(19) United States
(12) Patent Application Publication
(10) Pub. No.: US 2023/0116455 A1
(43) Pub. Date: Apr. 13, 2023

(54) BASE STATION APPARATUS, RELAY APPARATUS, CONTROL METHOD, AND COMPUTER-READABLE STORAGE MEDIUM FOR EXECUTING HANDOVER PROCESSING OF RELAY APPARATUS

(71) Applicant: KDDI CORPORATION, Tokyo (JP)

(72) Inventors: Hiroki TAKEDA, Tokyo (JP); Yanwei LI, Tokyo (JP)

(21) Appl. No.: 18/080,318

(22) Filed: Dec. 13, 2022

Related U.S. Application Data
(63) Continuation of application No. PCT/JP2021/024129, filed on Jun. 25, 2021.

(30) Foreign Application Priority Data
Jun. 26, 2020 (JP) 2020-110807

(51) Int. Cl. H04W 36/08; H04W 36/00

(52) U.S. Cl. CPC H04W 36/08; H04W 36/0055

(57) ABSTRACT

A base station apparatus specifies, in a case where a relay apparatus connected to the base station apparatus performs a handover to another base station apparatus, a communication apparatus connected to the base station apparatus via the relay apparatus. The base station apparatus executes, in processing for performing a handover of the relay apparatus to the other base station apparatus, processing for performing a handover of also the specified communication apparatus to the other base station apparatus, and transmits, during the processing, to the other base station apparatus, a control signal in which control data for a handover of the relay apparatus and control data for a handover of the communication apparatus are multiplexed.

### CROSS-REFERENCE TO RELATED APPLICATION(S)

This application is a continuation of International Patent Application No. PCT/JP2021/024129 filed on Jun. 25, 2021, which claims priority to and the benefit of Japanese Patent Application No. 2020-110807 filed Jun. 26, 2020, the entire disclosures of which are incorporated herein by reference.

### BACKGROUND OF THE INVENTION

### Field of the Invention

The present invention relates to a handover technique of a relay apparatus that relays communication between a base station apparatus and a terminal apparatus.

### Description of the Related Art

In 3rd Generation Partnership Project (3GPP), a technique for applying, to a backhaul link, a method for a terminal apparatus to access a network, and making the method usable has been considered (see 3GPP, TR38.874, V16.0.0, December, 2018). This technique is called “Integrated Access and Backhaul (IAB)”. A relay apparatus called “IAB node” establishes connection to a 5G base station apparatus (IAB donor) using a wireless link, for example. At this time, the IAB node may be directly connected to the IAB donor by establishing a wireless link, or may be indirectly connection to the IAB donor by establishing a wireless link to another IAB node connected directly or indirectly to the IAB donor. At this time, the IAB node functions as a terminal apparatus connected to the base station apparatus, and thereby establishes wireless connection to the above-mentioned other apparatus (upstream apparatus) on the IAB donor side. In addition, after connection to the IAB donor has been established, the IAB node can establish connection to another IAB node or a terminal apparatus that is to be connected to the IAB donor. In this case, the IAB node operates in a similar manner to the base station apparatus, and establishes wireless connection to a terminal apparatus or another IAB node that operates as a terminal apparatus (downstream apparatus). In this manner, the IAB node has a terminal function (MT, Mobile Termination) and a function (DU, Distributed Unit) for performing an operation similar to that of a base station apparatus, and can relay communication between an upstream apparatus and a downstream apparatus using these functions.

In 3GPP release 17, starting consideration on a topology change technique that is accompanied by a switch of an IAB donor, namely a connection partner of an IAB node has been proposed (3GPP, RP-193251, December, 2019). With this technique, when an IAB node installed in a mobile object such as a train or a bus moves, it is possible to maintain communication of the IAB donor itself and communication of another apparatus connected to the IAB donor.

### SUMMARY OF THE INVENTION

The present invention provides a technique for streamlining processing that is performed when an IAB node switches a connection destination thereof, namely an IAB donor.

A base station apparatus according to one mode of the present invention includes: one or more processors; and one or more memories that store a computer-readable instruction for causing, when executed by the one or more processors, the base station apparatus to: specify, in a case where a relay apparatus connected to the base station apparatus performs a handover to another base station apparatus, a communication apparatus connected to the base station apparatus via the relay apparatus, and execute processing for performing a handover of the relay apparatus to the other base station apparatus, and, when performing a handover of the relay apparatus to the other base station apparatus, the base station apparatus executes processing for performing a handover of also the specified communication apparatus to the other base station apparatus, and the processing that is executed by the base station apparatus includes transmitting, to the other base station apparatus, a control signal in which control data for a handover of the relay apparatus and control data for the communication apparatus are multiplexed.

A base station apparatus according to another mode of the present invention includes: one or more processors; and one or more memories that store a computer-readable instruction for causing, when executed by the one or more processors, the base station apparatus to: execute, in a case where a relay apparatus connected to another base station apparatus performs a handover to the base station apparatus, handover processing for the relay apparatus, and the processing that is executed by the base station apparatus includes: receiving, from the other base station apparatus, control data for a handover of the relay apparatus and control data for a handover of a communication apparatus connected to the base station apparatus via the relay apparatus, generating a response signal in which response data for the relay apparatus and response data for the communication apparatus are multiplexed, in accordance with receiving the control data for the relay apparatus and the communication apparatus, and transmitting the response signal to the other base station apparatus.

A relay apparatus according to one mode of the present invention includes: one or more processors; and one or more memories that store a computer-readable instruction for causing, when executed by the one or more processors, the relay apparatus to: receive, from a first base station apparatus connected to the relay apparatus, a control message in which first control information for a handover of the relay apparatus and second control information for a communication apparatus connected to the first base station apparatus via the relay apparatus are multiplexed, in a case where a handover is performed from the first base station apparatus to a second base station apparatus, extract the first control information and the second control information by separating the control message, execute a handover to the second base station apparatus based on the first control information, and transmit the second control information to the communication apparatus.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing an exemplary configuration of a wireless communication system.

FIG. 2 is a diagram showing an exemplary hardware configuration of an IAB donor and an IAB node.

FIG. 3 is a diagram showing an exemplary functional configuration of the IAB donor.

FIG. 4 is a diagram showing an exemplary functional configuration of the IAB node.

FIG. 5 is a diagram showing an example of flow of processing that is executed by a wireless communication system.

### ESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

FIG. 1 shows an exemplary configuration of a wireless communication system according to the present embodiment. The wireless communication system according to the present embodiment is a relay transmission system that is based on Integrated Access and Backhaul (IAB) stipulated in 3GPP, and is constituted by an IAB donor 101 and IAB node 111. The IAB node 111 is a relay apparatus that relays communication between the IAB donor 101 and a terminal apparatus 121 or a terminal apparatus 122. That is to say, the terminal apparatus 121 or the terminal apparatus 122 is connected to the IAB donor 101 via the IAB node 111. Note that it may be interpreted that the IAB donor functions as a base station apparatus, and the IAB node functions as a relay apparatus. In the present embodiment, due to movement of the IAB node 111, deterioration in the quality of communication with the IAB donor 101 connected to the IAB node 111, or the like, connection to the IAB donor 101 is switched to connection to another IAB donor, namely an IAB donor 102 (a handover is performed).

The terminal apparatus 121 and the terminal apparatus 122 are connected to the IAB donor 101 via the IAB node 111. Therefore, in accordance with the IAB node 111 performing a handover to the IAB donor 102, the terminal apparatus 121 and the terminal apparatus 122 also require processing for changing a connection destination. At this time, conventionally, for processing for changing a connection destination of each terminal apparatuses, various messages need to be individually transmitted/received for the terminal apparatus. Therefore, particularly, if a large number of terminal apparatuses and other IAB nodes are connected downstream of the IAB node 111, the signaling overhead may increase to too high a degree to ignore.

Therefore, in the present embodiment, when there is a need to change an IAB donor, namely a connection destination of the IAB node 111, the IAB donor 101 that is a handover source multiplexes control data for performing a handover of the IAB node 111 and control data for a handover of the terminal apparatuses and other IAB nodes connected downstream of the IAB node 111, to generate a control signal for a handover, and transmits the control signal to the IAB donor 102 that is a handover destination. That is to say, when following a conventional procedure, the IAB donor 101 separately generates and transmits a control signal for a handover of the IAB node 111 and control signals for a handover of the terminal apparatuses and other IAB nodes connected downstream of the IAB node 111 and, on the other hand, in the present embodiment, one control signal in which these control signals are multiplexed is generated and transmitted. Note that, control data for a handover may include identification information (ID) and the name of each of the terminal apparatuses (the IAB node 111, the terminal apparatus 121, and the terminal apparatus 122), and information regarding a connection parameter that has been used by the terminal apparatus. In addition, a configuration may be adopted in which, for example, if there are a large number of IAB nodes and terminal apparatuses that are to perform a handover, the IAB donor 101 multiplexes control data for a predetermined number of IAB nodes and terminal apparatuses to generate one control signal, and generates another control signal for control data for the rest of the IAB nodes and terminal apparatuses. Note that this control signal may correspond to a HANDOVER REQUEST message that is transmitted from a base station apparatus that is a handover source to a base station apparatus that is a handover destination, in a conventional method. Note that, having transmitted this control signal, the IAB donor 101 may erase information regarding the IAB node 111, and the terminal apparatuses and other IAB nodes connected downstream of the IAB node 111.

Note that the above-mentioned identification information (ID) can be a ReestabUE-Identity derived (calculated, for example) from Cell Radio Network Temporary Identifier (C-RNTI), or C-RNTI and physical cell ID (physCellId), which is an identifier that is allocated to each of the terminal apparatuses and IAB nodes by the base station apparatus. In addition, if a communication apparatus connected downstream of the IAB node 111 is an IAB node, Global NG-RAN Node ID or IP address allocated to the IAB node (as a 5G wireless access network node) may be used as identification information (ID).

On receiving a control signal in which control data for a handover of IAB nodes and terminal apparatuses is multiplexed, the IAB donor 102 that is a handover destination transmits a response signal to the control signal in which data is multiplexed, to the IAB donor 101. Note that, in this response signal, response data for the IAB node 111 and response data for the terminal apparatuses and other IAB nodes connected downstream of the IAB node 111 may be multiplexed. The response data here may include, for the IAB nodes and terminal apparatuses, information regarding connection parameters that are to be used after a handover and that are determined, for example, based on connection parameters that have been used. Note that this response signal may correspond to a Handover Request Acknowledge message that is transmitted from a base station apparatus that is a handover destination to a base station apparatus that is a handover source in a conventional method.

Note that the IAB donor 102 may multiplex response data on the condition that control data for the IAB node 111 and control data for the terminal apparatuses and other IAB nodes connected downstream of the IAB node 111 are multiplexed to the control signal received from the IAB donor 101, for example. In addition, a configuration may also be adopted in which the IAB donors 101 and 102 exchange information regarding the capability thereof in advance, and if the partner apparatus of each of the IAB donors 101 and 102 supports processing that is performed on multiplexed control data for a handover and multiplexed response data, the IAB donor transmits a control signal or response signal in which data is multiplexed, to the partner apparatus.

On receiving a response signal in which response data is multiplexed, the IAB donor 101 transmits, to the IAB node 111, a control message in which control information for a handover for the IAB node 111 and control information for a handover for the terminal apparatuses and other IAB nodes connected downstream of the IAB node 111 are multiplexed. At this time, when receiving a response signal in which response data is multiplexed, the IAB donor 101 may transmit information for each of the terminal apparatuses as is to the IAB node 111, or may decode each pieces of the information once and then reconfigure the information so as to generate a control message. In addition, when receiving a response signal in which response data is multiplexed, the IAB donor 101 may separate the response data so as to individually prepare control information for a handover for the IAB node 111 and control information for a handover for the terminal apparatuses and other IAB nodes connected downstream of the IAB node 111, and transmit the control information to the IAB node 111. That is to say, control information for a handover of apparatuses may be separated by the IAB node 111, or may be separated by the IAB donor 101. Note that, here, the control information for a handover corresponds to a conventional RRC Reconfiguration message, for example. Here, the control information for the IAB node 111 may include information indicating that processing (for example, random access processing) for establishing synchronization with the connection destination to which a switch is to be made (IAB donor B) is necessary. On the other hand, there is no change in the partner apparatus (for example, the IAB node 111, for the terminal apparatus 121 and the terminal apparatus 122) to which the terminal apparatuses and other IAB nodes connected downstream of the IAB node 111 are directly connected, and thus control information for these apparatuses may include information indicating that synchronization establishment processing is not necessary. Note that a configuration may be adopted in which control information includes predetermined information only when synchronization establishment processing is necessary, and the predetermined information not being included implicitly indicates that synchronization establishment processing is not necessary. On the contrary, a configuration may also be adopted in which control information includes predetermined information only when synchronization establishment processing is not necessary, and the predetermined information not being included implicitly indicates that synchronization establishment processing is necessary. Note that, if the IAB node 111 supports processing that is performed on multiplexed control messages, the IAB donor 101 may transmit multiplexed control messages to the IAB node 111. In addition, the IAB donor 101 may multiplex control information for the terminal apparatus 121 and control information for the terminal apparatus 122 within one FIAP message that is to be transmitted from the IAB donor 101 to the IAB node 111. In this case, the control information for the IAB node 111 is transmitted by using an RRC Reconfiguration message, and the control information for the terminal apparatus 121 and the terminal apparatus 122 may be transmitted using RRC Reconfiguration messages of the terminal apparatus 121 and the terminal apparatus 122 that are multiplexed in the FlAP message.

Upon receiving this control message, the IAB node 111 extracts control information for the IAB node itself from the control message, and executes necessary processing such as synchronization establishment processing. In addition, the IAB node 111 individually transmits control messages (for example, the RRC Reconfiguration messages) included in the received control message, to the terminal apparatuses and other IAB nodes connected downstream of the IAB node 111. Note that, when transmitting a control message to another IAB node, the IAB node 111 may transmit a control message in which control information for terminal apparatuses and yet other IAB nodes connected downstream of the other IAB node is multiplexed. In this case, if the other IAB node supports processing that is performed on multiplexed control messages, the IAB node 111 may transmit multiplexed control messages.

The IAB node 111 then receives a response message (RRC Reconfiguration Complete message) to the control message, from the terminal apparatuses and other IAB nodes connected downstream of the IAB node 111. Note that a response message in which response messages from terminal apparatuses and yet other IAB nodes connected downstream of another IAB node are multiplexed may be received from the other IAB node. The IAB node 111 may then multiplex the response messages received from the terminal apparatuses and other IAB nodes connected downstream of the IAB node 111, and transmit the multiplexed response messages to the IAB donor 102 that is a handover destination.

Note that, when various signals (messages) are multiplexed and transmitted, information for only one signal out of information common to a plurality of signals to be multiplexed may be transmitted. If, for example, connection parameter common to a plurality of IAB nodes and terminal apparatuses is transmitted using a HANDOVER REQUEST message or a Handover Request Acknowledge message, a signal for one of the apparatuses that correspond to the common connection parameter may include a value indicating the connection parameter, and signals for the other apparatuses may include a value (for example, one-bit value) indicating that the connection parameter for the one apparatus is to be used. Accordingly, it is possible to prevent an increase in the information amount resulting from the same information being repeatedly transmitted. Note that, for example, regarding information indicating reference values for connection parameters and connection parameters for the IAB nodes and terminal apparatuses, information indicating the difference between a connection parameter and a reference value may be transmitted/received. The IAB node 111 and the terminal apparatuses and other IAB nodes connected downstream of the IAB node 111 may be configured to use CellGroupConfig as a common parameter, for example. In this case, only one value indicating CellGroupConfig is included in a signal, and information regarding parameters for a plurality of apparatuses does not need to include information regarding this value. Note that a signal may have any format as long as necessary information is transmitted/received.

Note that there is a need to perform setting of a relay path between the IAB donor 102 and the IAB node 111 (and other IAB nodes), using IAB. Also in a message that is used in this case, multiplexing may be used. A configuration may also be adopted in which, for example, when information regarding the IAB donor 102 (for example, information regarding the Central Unit) is notified to the IAB node 111 and the other IAB nodes connected downstream of the IAB node 111, one Fl message in which information is multiplexed is transmitted to the IAB node 111 and the other IAB nodes.

In this manner, when an IAB node performs a handover, a signal for the IAB node and signals for apparatuses (terminal apparatuses and IAB nodes) connected downstream of the IAB node are multiplexed and transmitted, and thereby the signaling amount can be reduced. In addition, as a result, for example, it is possible to prevent a time for transmitting/receiving a signal from being extended, and to shorten a period during which a communication service that is being provided to a terminal apparatus is disconnected.

Note that FIG. 1 illustrates a case in which the IAB node 111 is directly connected to the IAB donor 101 or the IAB donor 102, but may also be connected to the IAB donor via another IAB node. In addition, the terminal apparatus 121 or the terminal apparatus 122 may be another IAB node. In addition, FIG. 1 shows only a small number of IAB donors, IAB nodes, and terminal apparatuses, but there may be a larger number of IAB donors, IAB nodes, and terminal apparatuses without loss of generality.

Apparatus Configuration

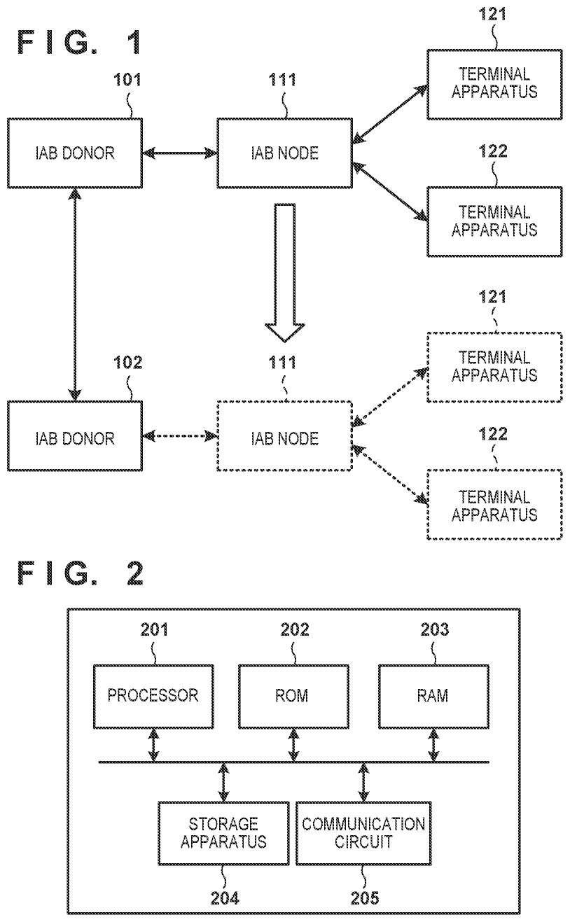

Next, the configuration of an IAB donor and an IAB node that execute processing such as that described above will be described. FIG. 2 shows an exemplary hardware configuration of an IAB donor or an IAB node. The IAB donor and the IAB node each include a processor 201, a ROM 202, a RAM 203, a storage apparatus 204, and a communication circuit 205, as an example. In the IAB donor and the IAB node, for example, a computer-readable program that realizes the above-described functions of the IAB donor and the IAB node, and is recorded in one of the ROM 202, the RAM 203, and the storage apparatus 204 is executed by the processor 201. Note that, the processor 201 may be replaced with one or more processors such as an application-specific integrated circuit (ASIC), Field Programmable Gate Arrays (FPGA), and a digital signal processor (DSP).

The processor 201 of the IAB donor or the IAB node controls the communication circuit 205 so as to perform communication with a partner apparatus (an IAB donor, an IAB node, a terminal apparatus, or the like), for example. Note that FIG. 2 shows a schematic diagram in which the IAB donor or the IAB node includes one communication circuit 205, but there is no limitation thereto. The IAB donor may include a communication circuit for communicating with an IAB node and a terminal apparatus, and a communication circuit for communicating with another IAB donor, for example. In addition, the IAB node may include a communication circuit for communicating with an IAB donor and a communication circuit for communicating with another IAB node and a terminal apparatus, for example.

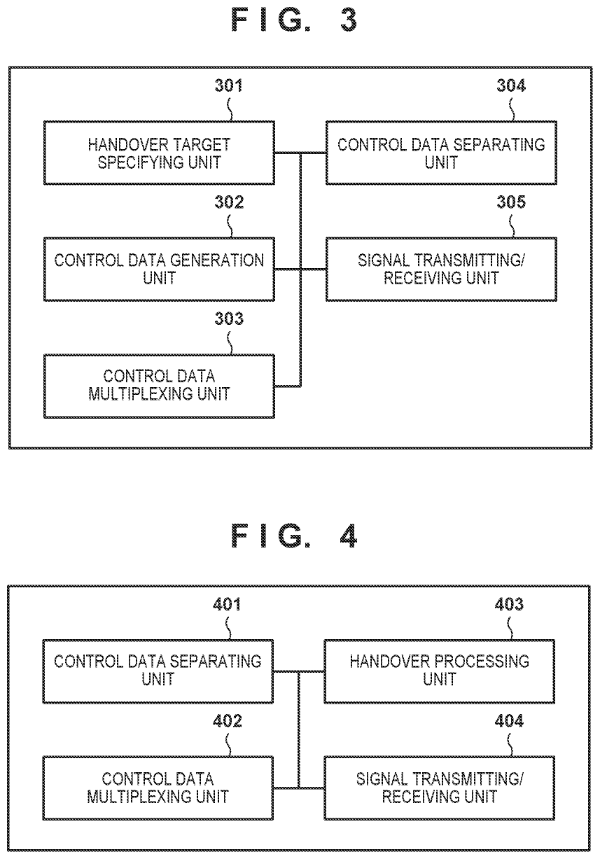

FIG. 3 shows an exemplary functional configuration of an IAB donor. The IAB donor is constituted by a handover target specifying unit 301, a control data generation unit 302, a control data multiplexing unit 303, a control data separating unit 304, and a signal transmitting/receiving unit 305, for example. Note that the IAB donor is configured to be capable of performing ordinary functions of an IAB donor in addition to these as a matter of course. In addition, a portion or the entirety of the functional configuration may be realized by the processor 201 executing a program stored in the ROM 202 or the storage apparatus 204, for example. In addition, dedicated hardware that realizes this functional configuration may be prepared. In addition, the functional configuration in FIG. 3 may also be realized by a processor included in the communication circuit 205 executing a dedicated program, for example. In addition, some of the functions in FIG. 3 may be omitted, or a function in FIG. 3 may be replaced with another function that has similar capability.

First, a case will be described in which the IAB donor is a handover source. The handover target specifying unit 301 determines whether or not to perform a handover of a terminal apparatus or an IAB node connected to the IAB donor based on a measurement result of wireless quality and the like of the terminal apparatus or the IAB node, for example. If it is determined that, for the handover, the IAB node is to perform a handover to another IAB donor, the handover target specifying unit 301 specifies the terminal apparatuses and other IAB nodes connected downstream of the IAB node as handover targets. The control data generation unit 302 generates handover request data for each of the apparatuses specified by the handover target specifying unit 301. This data may include information such as identification information (ID) and the name of each of the apparatuses, and a connection parameter that is currently used by the apparatus. The control data multiplexing unit 303 multiplexes the generated data, and the signal transmitting/receiving unit 305 transmits the multiplexed data (control signal) to the other IAB donor that is a handover destination.

Moreover, the signal transmitting/receiving unit 305 receives a response signal in response to the transmitted control signal, from the other IAB donor that is a handover destination. At this time, if, in the received response signal, for example, response data for the IAB node that is a handover target and response data for the terminal apparatuses and other IAB nodes connected downstream of the IAB node are multiplexed, the control data separating unit 304 separates the response data. That is to say, the control data separating unit 304 separates and extracts the response data for each of the apparatuses that are handover targets, in the received response signal. This response data may include identification information and the name of the apparatus, a connection parameter to be used between the apparatus and the IAB donor that is a handover destination, for example. At this time, the control data separating unit 304 may refer to response data for a second apparatus in which connection parameters are written, and obtain a connection parameter for response data for a first apparatus in which at least some of the common connection parameters are omitted during multiplexing. The control data generation unit 302 then generates control messages (for example, RRC Reconfiguration messages) to be transmitted to the apparatuses that are handover targets, based on the obtained data. The control data multiplexing unit 303 multiplexes the control messages, and the signal transmitting/receiving unit 305 transmits the multiplexed control messages to the IAB node that is to execute a handover. Note that the signal transmitting/receiving unit 305 may transmit information such as a connection parameter included in a response signal received from other IAB donor that is a handover destination, to the IAB node that transparently executes a handover. In this case, the IAB donor that is a handover source does not need to generate control data for the apparatuses again.

Next, a case will be described in which the IAB donor is a handover destination. The signal transmitting/receiving unit 305 receives, from another IAB donor that is a handover source, a control signal in which handover requests for respective apparatuses that are handover targets are multiplexed, as described above. The control data separating unit 304 then separates the multiplexed handover requests, and obtains the handover requests for the respective apparatuses. The control data separating unit 304 may refer to a handover request for a second apparatus in which connection parameters are written, and obtain a connection parameter for a handover request for a first apparatus in which at least some of common connection parameters are omitted during multiplexing, for example. In addition, for example, when a connection parameter of each apparatus is represented as a reference value of a connection parameter and a difference value for the apparatus during multiplexing, the control data separating unit 304 may specify a connection parameter based on the reference value and the difference value. The control data generation unit 302 then determines, based on the obtained data, a connection parameter to be used by each apparatus after a handover, and generates response data that includes the connection parameter in response to the handover request. The control data multiplexing unit 303 multiplexes the response data for the apparatuses, and generates a response signal, and the signal transmitting/receiving unit 305 transmits the response signal to the IAB donor that is a handover source.

Note that the signal transmitting/receiving unit 305 establishes connection to an IAB node based on random access processing executed for a handover by the IAB node. Thereafter, the signal transmitting/receiving unit 305 may receive, from the IAB node, a control message in which an RRC Reconfiguration Complete message of the IAB node and RRC Reconfiguration Complete messages of terminal apparatuses and other IAB nodes connected downstream of the IAB are multiplexed. The control data separating unit 304 then separates messages for the respective apparatuses from the received control message, and obtains the messages. Note that the IAB donor transmits/receives messages to/from the IAB node using an Fl interface in order to set a relay path after a handover, for example, but may be configured to multiplex signals and separate multiplexed signals at this time.

Next, an exemplary functional configuration of the IAB node will be described with reference to FIG. 4. The IAB node is constituted by a control data separating unit 401, a control data multiplexing unit 402, a handover processing unit 403, and a signal transmitting/receiving unit 404, for example. Note that the IAB node is configured to be capable of performing ordinary functions of an IAB node in addition to these as a matter of course. In addition, a portion or the entirety of the functional configuration may be realized by the processor 201 executing a program stored in the ROM 202 or the storage apparatus 204, for example. In addition, dedicated hardware that realizes this functional configuration may be prepared. In addition, the functional configuration in FIG. 4 may also be realized by a processor included in the communication circuit 205 executing a dedicated program, for example. In addition, some of the functions in FIG. 4 may be omitted, or a function in FIG. 4 may be replaced with another function that has similar capability.

When, for example, a control signal in which an RRC Reconfiguration message for the IAB node and RRC Reconfiguration messages for the terminal apparatuses and other IAB nodes connected downstream of the IAB nodes are multiplexed is received from the IAB donor that is a handover source via the signal transmitting/receiving unit 404, the control data separating unit 401 separates and extracts the messages. The signal transmitting/receiving unit 404 then transmits the separated messages to the terminal apparatuses and other IAB nodes connected downstream of the IAB node. The handover processing unit 403 executes processing such as random access processing in accordance with the RRC Reconfiguration message for the IAB node, in order to establish connection to the IAB donor that is a handover destination. Meanwhile, the signal transmitting/receiving unit 404 receives the RRC Reconfiguration Complete messages from the terminal apparatuses and other IAB nodes connected downstream of the IAB node, for example. The control data multiplexing unit 402 then multiplexes the received messages, and transmits the multiplexed messages, to the IAB donor to which connection has been established by the handover processing unit 403, via the signal transmitting/receiving unit 404.

### Flow of Processing

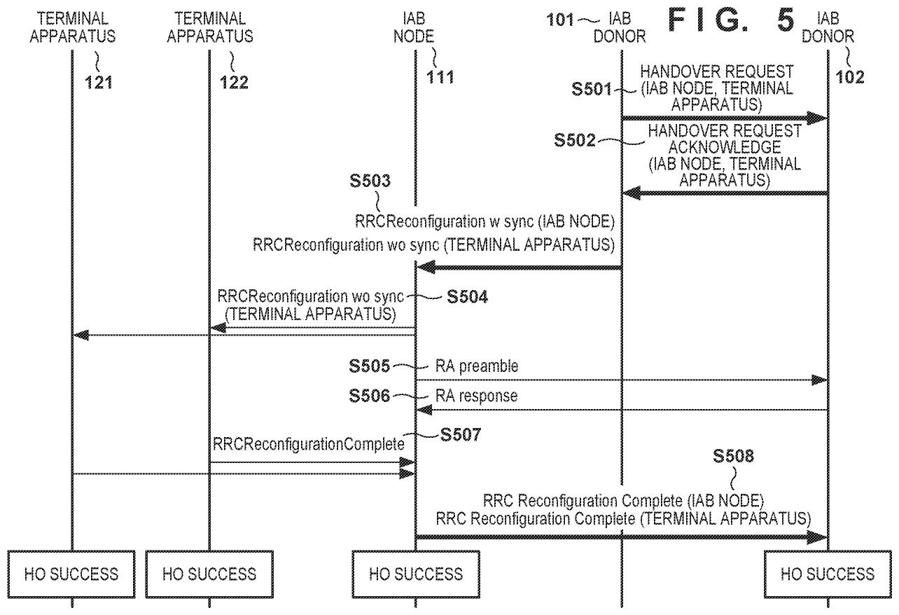

Next, an example of flow of processing that is executed by the wireless communication system will be described with reference to FIG. 5. Note that, here, flow of processing until the IAB node 111 completes execution of a handover from the IAB donor 101 to the IAB donor 102 will be described, and a description of message transmission/receiving via an F1 interface for setting a relay path that is to be executed after a handover is omitted. In addition, flow of processing to be described below is exemplary, and processing other than this may also be executed. An example will be described below in which the IAB donor 101 transmits multiplexed RRC Reconfiguration messages to the IAB node 111, but the IAB donor 101 may transmit the RRC Reconfiguration messages to apparatuses without multiplexing them. Other modifications may be made as a matter of course.

In this processing, first, the IAB donor 101 connected to the IAB node 111 determines that a handover of the IAB node 111 is to be performed, in accordance with deterioration in first wireless quality of a signal received by the IAB node 111 from the IAB donor 101, second wireless quality of a signal received by the IAB node 111 from the IAB donor 102 exceeding the first wireless quality by more than a predetermined level, or the like. The IAB donor 101 then specifies the terminal apparatuses and other IAB nodes connected downstream of the IAB node 111, and generates Handover Request messages for the apparatuses, and a Handover Request message for the IAB node 111. The IAB donor 101 then multiplexes the Handover Request messages, and transmits the multiplexed messages to the IAB donor 102 that is a handover destination (step S501). The IAB donor 102 separates the multiplexed Handover Request messages for the respective apparatuses, and obtains information such as connection parameters that are being used by the apparatuses. The IAB donor 102 then determines connection parameters to be used by the apparatuses after a handover, and the like, and generates Handover Request Acknowledge messages for the respective apparatuses, the messages including the information. The IAB donor 102 then multiplexes the messages, and transmits the multiplexed messages to the IAB donor 101 that is a handover source (step S502).

Upon receiving the multiplexed Handover Request Acknowledge messages, the IAB donor 101 generates RRC Reconfiguration messages for the IAB node 111 and the terminal apparatuses and other IAB nodes connected downstream of the IAB node 111, based on the received messages. The IAB donor 101 then multiplexes the generated messages, and transmits the multiplexed messages to the IAB node 111 (step S503). At this time, the RRC Reconfiguration message for the IAB node 111 may indicate that synchronization establishment processing such as random access processing is to be executed. On the other hand, the RRC Reconfiguration messages for the terminal apparatuses and other IAB nodes connected downstream of the IAB node 111 may indicate that synchronization establishment processing such as random access processing is not to be executed. Note that, in FIG. 5, “w sync” indicates that synchronization establishment processing is necessary, and “wo sync” indicates that synchronization establishment processing is not necessary.

Upon receiving the multiplexed RRC Reconfiguration messages, the IAB node 111 separates, extracts, and obtains the messages for the respective apparatuses, and transmits the obtained messages to the terminal apparatuses and other IAB nodes connected downstream of the IAB node 111 (step S504). In addition, the IAB node 111 executes random access processing and establishes synchronization with the IAB donor 102, based on the RRC Reconfiguration message for the IAB node 111 (steps 5505 and S506). Upon receiving the RRC Reconfiguration Complete messages from the terminal apparatuses and other IAB nodes connected downstream of the IAB node 111 (step S507), the IAB node 111 multiplexes the messages and an RRC Reconfiguration Complete message that the IAB node 111 is to transmit, and transmits the multiplexed messages to the IAB donor 102 (step S508).

A handover is performed successfully by performing this series of processing. The IAB node 111 and the other IAB nodes connected downstream of the IAB node 111 then set a relay path to the IAB donor 102, by transmitting/receiving messages via the F1 interface. Accordingly, the terminal apparatuses and other IAB nodes connected downstream of the IAB node 111 can communicate with the IAB donor 102.

With the technique according to the present embodiment, it is possible to reduce the amount of signaling messages when an IAB node performs a handover between IAB donors as described above, which makes it possible to prevent a time for transmitting/receiving signals from being extended, for example, and to shorten a period during which a communication service provided to a terminal apparatus is disconnected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A base station apparatus comprising:
one or more processors; and
one or more memories that store a computer-readable instruction for causing, when executed by the one or more processors, the base station apparatus to:
specify, in a case where a relay apparatus connected to the base station apparatus performs a handover to another base station apparatus, a communication apparatus connected to the base station apparatus via the relay apparatus; and
execute processing for performing a handover of the relay apparatus to the other base station apparatus,
wherein, when performing a handover of the relay apparatus to the other base station apparatus, the base station apparatus executes processing for performing a handover of also the specified communication apparauts to the other base station apparatus, and
the processing that is executed by the base station apparatus includes transmitting, to the other base station apparatus, a control signal in which control data for a handover of the relay apparatus and control data for a handover of the communication apparatus are multiplexed.

2. The base station apparatus according to claim 1, wherein
the processing that is executed by the base station apparatus further includes transmitting, to the relay apparatus, a control message in which control information for a handover of the relay apparatus and control information for a handover of the communication apparatus are multiplexed, based on a response signal to the control signal received from the other base station apparatus.

3. The base station apparatus according to claim 2, wherein
the control information for a handover of the relay apparatus indicates that the relay apparatus requires random access processing with the other base station apparatus.

4. The base station apparatus according to claim 2, wherein
the control information for a handover of the communication apparatus indicates that the communication apparatus does not require random access processing with the other base station apparatus.

5. The base station apparatus according to claim 1, wherein
the processing that is executed by the base station apparatus further includes transmitting, to the relay apparatus, control information for a handover of the relay apparatus and the control information for a handover of the communication apparatus without multiplexing the control information, based on a response signal to the control signal received from the other base station apparatus.

6. The base station apparatus according to claim 2, wherein
the control information is an RRC Reconfiguration message.

7. The base station apparatus according to claim 1, wherein
the control signal is Handover Request.

8. The base station apparatus according to claim 1, wherein
the processing that is executed by the base station apparatus further includes receiving a response signal to the control signal received from the other base station apparatus, the response signal being a signal in which response data for the relay apparatus and response data for the communication apparatus are multiplexed.

9. The base station apparatus according to claim 8, wherein
the processing that is executed by the base station apparatus further includes separating the response data for the relay apparatus and the response data for the communication apparatus from the response signal.

10. The base station apparatus according to claim 8, wherein
the response signal is Handover Request Acknowledge.

11. The base station apparatus according to claim 1, wherein
in a case where there is a parameter common between a first parameter for connection between the relay apparatus and the other base station apparatus and a second parameter for connection between the communication apparatus and the other base station apparatus, the base station apparatus generates a signal that includes only one value indicating the common parameter through multiplexing.

12. The base station apparatus according to claim 11, wherein
the common parameter includes CellGroupConfig.

13. A base station apparatus comprising:
one or more processors; and
one or more memories that store a computer-readable instruction for causing, when executed by the one or more processors, the base station apparatus to:
execute, in a case where a relay apparatus connected to another base station apparatus performs a handover to the base station apparatus, handover processing for the relay apparatus,
wherein the processing that is executed by the base station apparatus includes:
receiving, from the other base station apparatus, control data for a handover of the relay apparatus and control data for a handover of a communication apparatus connected to the base station apparatus via the relay apparatus,
generating a response signal in which response data for the relay apparatus and response data for the communication apparatus are multiplexed, in accordance with receiving the control data for the relay apparatus and the communication apparatus, and
transmitting the response signal to the other base station apparatus.

14. The base station apparatus according to claim 13, wherein
in a case of receiving, from the other base station apparatus, a control signal in which the control data for a handover of the relay apparatus and the control data for the communication apparatus are multiplexed, the base station apparatus generates the response signal in which the response data for the relay apparatus and the response data for the communication apparatus are multiplexed.

15. The base station apparatus according to claim 13, wherein
the control data is Handover Request.

16. The base station apparatus according to claim 13, wherein
the response data for the relay apparatus includes a first parameter for connection between the relay apparatus and the base station apparatus, and the response data for the communication apparatus includes a second parameter for connection between the communication apparatus and the base station apparatus, and
in a case where there is a parameter common between the first parameter and the second parameter, the base station apparatus generates the response signal that includes only one value indicating the common parameter through multiplexing.

17. The base station apparatus according to claim 16, wherein
the common parameter includes CellGroupConfig.

18. The base station apparatus according to claim 13, wherein
the response signal is Handover Request Acknowledge.

19. A relay apparatus comprising:
one or more processors; and
one or more memories that store a computer-readable instruction for causing, when executed by the one or more processors, the relay apparatus to:
receive, from a first base station apparatus connected to the relay apparatus, a control message in which first control information for a handover of the relay apparatus and second control information for a communication apparatus connected to the first base station apparatus via the relay apparatus are multiplexed, in a case where a handover is performed from the first base station apparatus to a second base station apparatus;
extract the first control information and the second control information by separating the control message;
execute a handover to the second base station apparatus based on the first control information; and
transmit the second control information to the communication apparatus.

20. The relay apparatus according to claim 19, wherein
the first control information indicates that the relay apparatus requires random access processing with the second base station apparatus.

21. The relay apparatus according to claim 19, wherein
the second control information indicates that the communication apparatus does not require random access processing with the second base station apparatus.

22. The relay apparatus according to claim 19, wherein
the relay apparatus generates a first response message to the first control information, receives a second response message to the second control information, from the communication apparatus, and multiplexes the first response message and the second response message, and transmits the multiplexed messages to the second base station apparatus.

23. The relay apparatus according to claim 22, wherein
the first response message and the second response message are RRC Reconfiguration Complete messages.

24. The relay apparatus according to claim 19, wherein
the first control information and the second control information are RRC Reconfiguration messages.

25. The relay apparatus according to claim 19, wherein
the second control information for one or more communication apparatuses connected to the first base station apparatus via the relay apparatus is multiplexed in an FlAP message, which is received by the relay apparatus.

26. A control method that is executed by a base station apparatus, comprising:
specifying, in a case where a relay apparatus connected to the base station apparatus performs a handover to another base station apparatus, a communication apparatus connected to the base station apparatus via the relay apparatus; and
executing processing for performing a handover of the relay apparatus to the other base station apparatus,
wherein, in the processing, when performing a handover of the relay apparatus to the other base station apparatus, the base station apparatus executes processing for performing a handover of also the specified communication apparatus to the other base station apparatus, and
in the processing, the base station apparatus transmits a control signal in which control data for a handover of the relay apparatus and control data for a handover of the communication apparatus are multiplexed, to the other base station apparatus.

27. A control method that is executed by a base station apparatus, comprising:
executing handover processing for a relay apparatus connected to another base station apparatus, in a case where the relay apparatus performs a handover to the base station apparatus,
wherein the handover processing includes:
receiving, from the other base station apparatus, control data for a handover of the relay apparatus and control data for a handover of a communication apparatus connected to the base station apparatus via the relay apparatus,
generating a response signal in which response data for the relay apparatus and response data for the communication apparatus are multiplexed, in accordance with receiving the control data for the relay apparatus and the communication apparatus, and
transmitting the response signal to the other base station apparatus.

28. A control method that is executed by a relay apparatus, comprising:
receiving, in a case of performing a handover from a first base station apparatus connected to the relay apparatus to a second base station apparatus, a control message in which first control information for a handover of the relay apparatus and second control information for a communication apparatus connected to the first base station apparatus via the relay apparatus are multiplexed, from the first base station apparatus;
extracting the first control information and the second control information by separating the control message;
executing a handover to the second base station apparatus based on the first control information; and
transmitting the second control information to the communication apparatus.

29. A non-transitory computer-readable storage medium that stores a program for causing a computer included in a base station apparatus to perform a method including:
specifying, in a case where a relay apparatus connected to the base station apparatus performs a handover to another base station apparatus, a communication apparatus connected to the base station apparatus via the relay apparatus; and
executing processing for performing a handover of the relay apparatus to the other base station apparatus,
wherein, in the processing, when performing a handover of the relay apparatus to the other base station apparatus, the base station apparatus executes processing for performing a handover of also the specified communication apparatus to the other base station apparatus, and
in the processing, the base station apparatus transmits a control signal in which control data for a handover of the relay apparatus and control data for a handover of the communication apparatus are multiplexed, to the other base station apparatus.

30. A non-transitory computer-readable storage medium that stores a program for causing a computer included in a base station apparatus to perform a method including:
executing handover processing for a relay apparatus connected to another base station apparatus, in a case where the relay apparatus performs a handover to the base station apparatus,
wherein the handover processing includes:
receiving, from the other base station apparatus, control data for a handover of the relay apparatus and control data for a handover of a communication apparatus connected to the base station apparatus via the relay apparatus,
generating a response signal in which response data for the relay apparatus and response data for the communication apparatus are multiplexed, in accordance with receiving the control data for the relay apparatus and the communication apparatus, and
transmitting the response signal to the other base station apparatus.

31. A non-transitory computer-readable storage medium that stores a program for causing a computer included in a relay apparatus to perform a method including:
receiving, in a case of performing a handover from a first base station apparatus connected to the relay apparatus to a second base station apparatus, a control message in which first control information for a handover of the relay apparatus and second control information for a communication apparatus connected to the first base station apparatus via the relay apparatus are multiplexed, from the first base station apparatus;
extracting the first control information and the second control information by separating the control message;
executing a handover to the second base station apparatus based on the first control information; and
transmitting the second control information to the communication apparatus.
